(19) United States
(12) Patent Application Publication
(10) Pub. No.: US 2026/0197524 A1
(43) Pub. Date: Jul. 9, 2026

(54) DISPLAY DEVICE AND METHOD FOR OPERATING SAME

(71) Applicant: LG ELECTRONICS INC., Seoul (KR)

(72) Inventor: Hyunjoo KANG, Seoul (KR)

(73) Assignee: LG ELECTRONICS INC., Seoul (KR)

(21) Appl. No.: 18/868,431

(22) PCT Filed: May 24, 2022
(86) PCT No.: PCT/KR2022/007324

§ 371 Date: Nov. 22, 2024

(51) Int. Cl. H04N 21/443; H04N 17/04; H04N 21/45

(52) U.S. Cl. CPC H04N 21/4432; H04N 17/04; H04N 21/4516

(57) ABSTRACT

A display device and a method for operating same are disclosed. The display device according to an embodiment of the present disclosure may comprise: a first processing unit for, in response to receiving a power-on request signal, reading correction data from a panel so as to correct a defect in the panel; and a second processing unit for receiving correction data from the first processing unit, calculating inspection data for the correction data, and storing the received correction data and the calculated inspection data in a memory. Here, when the power-on request signal is received after correcting the defect of the panel, the second processing unit may control the operation of the first processing unit to read first inspection data calculated for the correction data from the panel.

### TECHNICAL FIELD

The present disclosure relates to a display device that minimizes power-on time and a method of operating the same.

### RELATED ART

Digital TV services using wired or wireless communication networks are becoming popular. Digital TV services can provide a variety of services that cannot be provided by existing analog broadcasting services.

For example, IPTV (Internet Protocol Television), a type of digital TV service, and smart TV service provide interactivity that allows users to actively select the type of program to watch and the viewing time. IPTV and smart TV services can provide various additional services, such as Internet search, home shopping, and online games, based on this interactivity.

In other words, as the demand for higher quality and service increases, digital TVs have more basic preparation procedures to perform until the screen is provided upon power-on request, so it takes a long time to provide the initial screen. It is becoming.

In this way, as digital TVs provide service screens upon power-on requests, i.e., the power-on time becomes longer, there is a problem in that user dissatisfaction occurs and product satisfaction decreases as a result.

Therefore, there is a need to minimize power-on time, and a solution is required.

### Technical Problem

One technical object of the present disclosure is to provide a display device capable of reducing the power-on time described above.

Another technical object of the present disclosure is to provide a display device in which the demura data processing process for resolving the mura of the panel is optimized.

### Technical Solution

A display device according to an embodiment of the present disclosure may include a first processor configured to read correction data from a panel and correct defects in the panel according to a reception of a power-on request signal; and a second processor configured to receive the correction data from the first processor, calculate inspection data for the correction data, and store the received correction data and the calculated inspection data in a memory. In this case, the second processor is configured to control an operation of the first processor to read first inspection data calculated for correction data from the panel when a power-on request signal is received after defect correction of the panel.

A display device according to an embodiment of the present disclosure includes: a memory; a first processor configured to read correction data from a panel and correct defects in the panel; and a second processor, based on receiving a power-on request signal, configured to read the first inspection data of the correction data from the panel, read the second inspection data corresponding to the first inspection data from the memory, and controls the operation of the first processor to read correction data from the panel according to a comparison result of the first inspection data and the second inspection data.

A method of driving a display device according to an embodiment of the present disclosure may include receiving a power-on request signal; reading correction data from a panel and correcting defects in the panel; receiving the correction data and calculating test data for the correction data; and storing the received correction data and the calculated inspection data, wherein, when the power-on request signal is received after defects in the panel are corrected, it is controlled to read inspection data of the correction data instead of correction data from the panel.

### Effects of the Invention

According to at least one of the various embodiments of the present disclosure, there is an effect of optimizing the demura data processing process in the display device.

According to at least one of the various embodiments of the present disclosure, there is an effect of efficiently managing the resources of the display device.

According to at least one of the various embodiments of the present disclosure, there is an effect of reducing the power-on time in the display device.

### BRIEF DESCRIPTION OF THE DRAWINGS

FIG. 1 illustrates a block diagram of the configuration of a display device according to an embodiment of the present invention.

FIG. 2 is a block diagram of a remote control device according to an embodiment of the present invention.

FIG. 3 illustrates an example of the actual configuration of a remote control device according to an embodiment of the present invention.

FIG. 4 illustrates an example of utilizing a remote control device according to an embodiment of the present invention.

FIGS. 5 to 8 are diagrams to explain correction data processing between an electronic device and a panel according to an embodiment of the present invention.

FIGS. 9 to 11 are flowcharts illustrating a correction data processing process between an electronic device and a panel according to an embodiment of the present invention.

### BEST MODE

Hereinafter, embodiments related to the present invention will be described in more detail with reference to the drawings. The suffixes “module” and “part” for components used in the following description are given or used interchangeably only for the ease of preparing the specification, and do not have distinct meanings or roles in themselves.

The display device according to an embodiment of the present invention is, for example, an intelligent display device that adds a computer support function to the broadcast reception function, and is faithful to the broadcast reception function while adding an Internet function, etc., such as a handwriting input device and a touch screen. Alternatively, it can be equipped with a more convenient interface such as a spatial remote control. In addition, by supporting wired or wireless Internet functions, it is possible to connect to the Internet and a computer and perform functions such as email, web browsing, banking, or gaming. A standardized general-purpose Operating System (OS) can be used for these various functions.

Accordingly, in the display device described in the present invention, for example, various applications can be freely added or deleted on a general-purpose OS kernel, so various user-friendly functions can be performed. More specifically, the display device can be, for example, a network TV, HBBTV, smart TV, LED TV, OLED TV, etc., and in some cases, can also be applied to a smartphone.

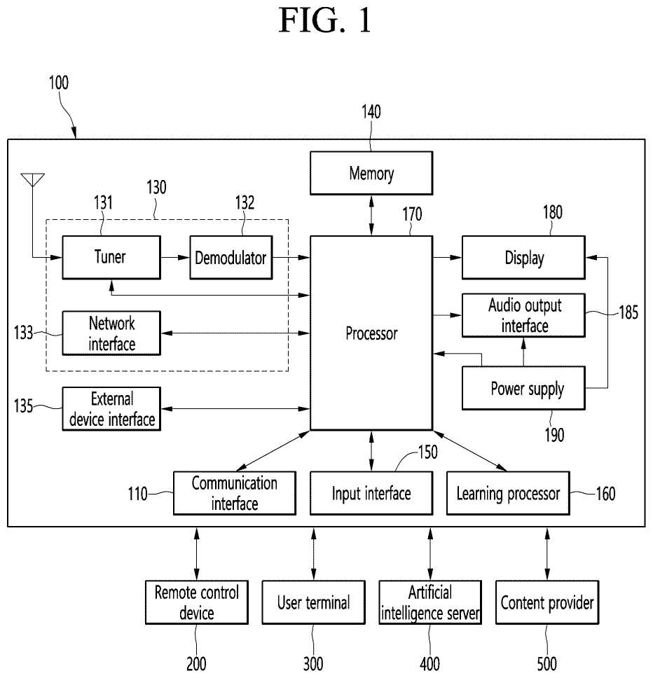

FIG. 1 illustrates a block diagram of the configuration of a display device according to an embodiment of the present invention.

Referring to FIG. 1, the display device 100 includes a broadcast receiver 130, an external device interface 135, a memory 140, a user input interface 150, a controller 170, a wireless communication interface 173, and a display. It can include 180, a speaker 185, and a power supply circuit 190.

The broadcast receiver 130 can include a tuner 131, a demodulator 132, and a network interface 133.

The tuner 131 can select a specific broadcast channel according to a channel selection command. The tuner 131 can receive a broadcast signal for a specific selected broadcast channel.

The demodulator 132 can separate the received broadcast signal into a video signal, an audio signal, and a data signal related to the broadcast program, and can restore the separated video signal, audio signal, and data signal to a form that can be output.

The external device interface 135 can receive an application or application list within an adjacent external device and transfer it to the controller 170 or memory 140.

The external device interface 135 can provide a connection path between the display device 100 and an external device. The external device interface 135 can receive one or more of video and audio output from an external device connected wirelessly or wired to the display device 100 and transmit it to the controller 170. The external device interface 135 can include a plurality of external input terminals. The plurality of external input terminals can include an RGB terminal, one or more High-Definition Multimedia Interface (HDMI) terminals, and a component terminal.

An image signal from an external device input through the external device interface 135 can be output through the display 180. A voice signal from an external device input through the external device interface 135 can be output through the speaker 185.

An external device that can be connected to the external device interface 135 can be any one of a set-top box, Blu-ray player, DVD player, game console, sound bar, smartphone, PC, USB memory, or home theater, but this is only an example.

The network interface 133 can provide an interface for connecting the display device 100 to a wired/wireless network including an Internet network. The network interface 133 can transmit or receive data with other users or other electronic devices through a connected network or another network linked to the connected network.

Additionally, some of the content data stored in the display device 100 can be transmitted to a selected user or selected electronic device among other users or other electronic devices pre-registered in the display device 100.

The network interface 133 can access a certain web page through a connected network or another network linked to the connected network. In other words, it can access a certain web page through a network and transmit or receive data with the corresponding server.

And the network interface 133 can receive content or data provided by a content provider or network operator. That is, the network interface 133 can receive content and information related thereto, such as movies, advertisements, games, VODs, and broadcast signals, provided from a content provider or network provider through a network.

Additionally, the network interface 133 can receive firmware update information and update files provided by a network operator, and can transmit data to the Internet, a content provider, or a network operator.

The network interface 133 can select and receive a desired application from among applications open to the public through a network.

The memory 140 stores programs for processing and controlling each signal in the controller 170, and can store signal-processed video, voice, or data signals.

In addition, the memory 140 can perform a function for temporarily storing video, voice, or data signals input from the external device interface 135 or the network interface 133, and can provide information about a predetermined image through the channel memory function.

The memory 140 can store an application or application list input from the external device interface 135 or the network interface 133.

The display device 100 can play content files (video files, still image files, music files, document files, application files, etc.) stored in the memory 140 and provide them to the user.

The user input interface 150 can transmit a signal input by the user to the controller 170 or transmit a signal from the controller 170 to the user. For example, the user input interface 150 can be configured according to various communication methods such as Bluetooth™, Ultra Wideband (UWB), ZigBee, Radio Frequency (RF) communication, or Infrared (IR) communication. Control signals such as power on/off, channel selection, and screen settings can be received and processed from the remote control device 200, or control signals from the controller 170 can be processed to be transmitted to the remote control device 200.

Additionally, the user input interface 150 can transmit control signals input from local keys (not shown) such as power key, channel key, volume key, and setting value to the controller 170.

The video signal processed by the controller 170 can be input to the display 180 and displayed as an image corresponding to the video signal. Additionally, the image signal processed by the controller 170 can be input to an external output device through the external device interface 135.

The voice signal processed by the controller 170 can be output as audio to the speaker 185. Additionally, the voice signal processed by the controller 170 can be input to an external output device through the external device interface 135.

In addition, the controller 170 can control overall operations within the display device 100.

In addition, the controller 170 can control the display device 100 by a user command or internal program input through the user input interface 150, and connects to the network to download an application or application list desired by the user within the display device (100).

The controller 170 allows channel information selected by the user to be output through the display 180 or speaker 185 along with the processed video or audio signal.

In addition, the controller 170 controls video signals or video signals from an external device, for example, a camera or camcorder, input through the external device interface 135, according to an external device image playback command received through the user input interface 150. The audio signal can be output through the display 180 or speaker 185.

Meanwhile, the controller 170 can control the display 180 to display an image, for example, a broadcast image input through the tuner 131, an external input image input through the external device interface 135, Alternatively, an image input through the network interface unit or an image stored in the memory 140 can be controlled to be displayed on the display 180. In this case, the image displayed on the display 180 can be a still image or a moving image, and can be a 2D image or a 3D image.

Additionally, the controller 170 can control the playback of content stored in the display device 100, received broadcast content, or external input content, which can include broadcast video, external input video, audio files, it can be in various forms, such as still images, connected web screens, and document files.

The wireless communication interface 173 can communicate with external devices through wired or wireless communication. The wireless communication interface 173 can perform short range communication with an external device. For this purpose, the wireless communication interface 173 includes Bluetooth, Radio Frequency Identification (RFID), Infrared Data Association (IrDA), UWB, ZigBee, Near Field Communication (NFC), Wireless-Fidelity (Wi-Fi), and Wi-Fi.-Short-distance communication can be supported using at least one of Fi Direct and Wireless USB (Wireless Universal Serial Bus) technologies. This wireless communication interface 173 is between the display device 100 and a wireless communication system, between the display device 100 and another display device 100, or between the display device 100 and the display device 100 through wireless area networks. Wireless communication between networks where the display device 100 or an external server is located can be supported. Local area wireless networks can be wireless personal area networks.

Here, the other display device is a wearable device capable of exchanging data with (or interoperating with) the display device 100 according to the present invention (for example, a smartwatch, smart glasses, a head-mounted display (HMD), or a mobile terminal such as a smart phone). The wireless communication interface 173 can detect (or recognize) a wearable device capable of communication around the display device 100.

Furthermore, if the detected wearable device is a device authenticated to communicate with the display device 100 according to the present invention, the controller 170 sends at least a portion of the data processed by the display device 100 to the wireless communication interface 173. It can be transmitted to a wearable device through. Accordingly, a user of a wearable device can use data processed by the display device 100 through the wearable device.

The display 180 converts video signals, data signals, and on screen display (OSD) signals processed by the controller 170 or video signals and data signals received from the external device interface 135 into R, G, and B signals, respectively. A driving signal can be generated by conversion.

Meanwhile, the display device 100 shown in FIG. 1 is only one embodiment of the present invention. Some of the illustrated components can be integrated, added, or omitted depending on the specifications of the display device 100 that is actually implemented.

That is, as needed, two or more components can be combined into one component, or one component can be subdivided into two or more components. In addition, the functions performed by each block are for explaining embodiments of the present invention, and the specific operations or devices do not limit the scope of the present invention.

According to another embodiment of the present invention, unlike shown in FIG. 1, the display device 100 does not have a tuner 131 and a demodulator 132 but has a network interface 133 or an external device interface 135 to also receive and play video through them.

For example, the display device 100 includes an image processing device such as a set-top box (STB) for receiving broadcast signals or contents according to various network services, and content input from the image processing device. It can be implemented separately as a content playback device that plays.

In this case, the method of operating a display device according to an embodiment of the present invention to be described below includes not only the display device 100 as described with reference to FIG. 1, but also an image processing device such as the separate set-top box or a display 180 and a content playback device having an audio output unit (speaker) 185.

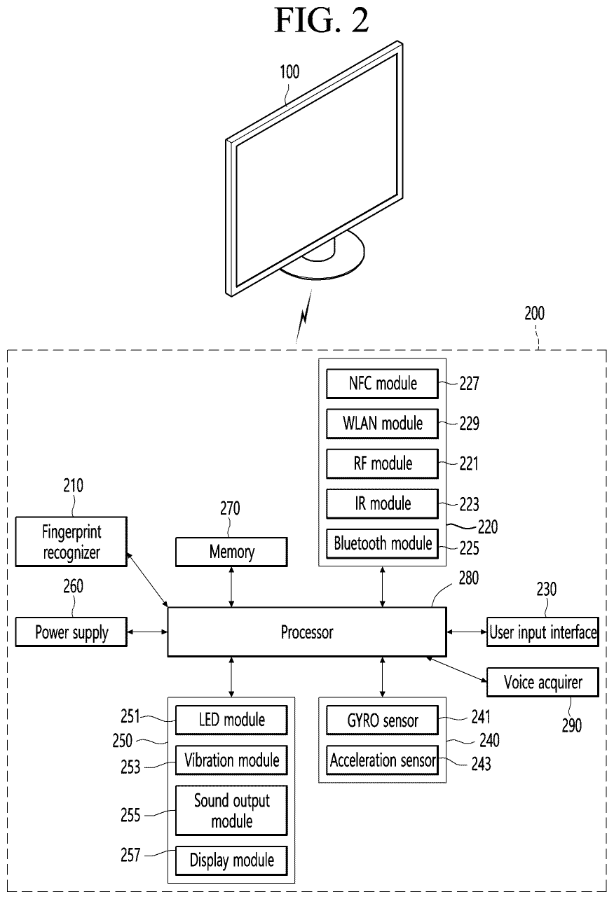

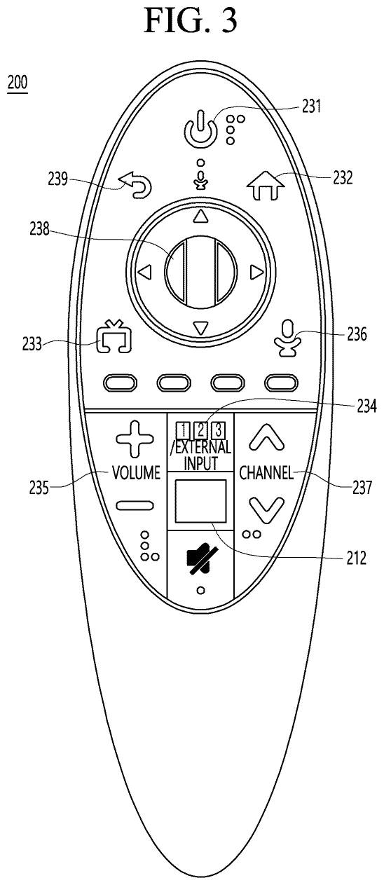

Next, with reference to FIGS. 2 and 3, a remote control device 200 according to an embodiment of the present invention will be described.

FIG. 2 is a block diagram of a remote control device 200 according to an embodiment of the present invention, and FIG. 3 illustrates an example of the actual configuration of the remote control device 200 according to an embodiment of the present invention.

First, referring to FIG. 2, the remote control device 200 includes a fingerprint reader 210, a wireless communication circuit 220, a user input interface 230, a sensor 240, an output interface 250, and a power supply circuit 260, memory 270, controller 280, and microphone 290.

Referring to FIG. 2, the wireless communication circuit 220 transmits and receives signals to and from any one of the display devices according to the embodiments of the present invention described above.

The remote control device 200 has an RF circuit 221 capable of transmitting and receiving signals to and from the display device 100 in accordance with RF communication standards, and is capable of transmitting and receiving signals to and from the display device 100 in accordance with IR communication standards. An IR circuit 223 can be provided. Additionally, the remote control device 200 can be provided with a Bluetooth circuit 225 capable of transmitting and receiving signals to and from the display device 100 according to the Bluetooth communication standard. In addition, the remote control device 200 is provided with an NFC circuit 227 capable of transmitting and receiving signals with the display device 100 in accordance with Near Field Communication (NFC) communication standards, and displays and transmits signals in accordance with Wireless LAN (WLAN) communication standards. A WLAN circuit 229 capable of transmitting and receiving signals to and from the device 100 can be provided.

Additionally, the remote control device 200 transmits a signal containing information about the movement of the remote control device 200 to the display device 100 through the wireless communication circuit 220.

Meanwhile, the remote control device 200 can receive a signal transmitted by the display device 100 through the RF circuit 221 and, if necessary, turn on/off the display device 100 through the IR circuit 223. Commands for turning off, changing channels, changing volume, etc. can be sent.

The user input interface 230 can be comprised of a keypad, button, touch pad, or touch screen. A user can manipulate the user input interface 230 to input commands related to the display device 100 through the remote control device 200. If the user input interface 230 includes a hard key button, the user can input a command related to the display device 100 to the remote control device 200 through a push operation of the hard key button. This will be explained with reference to FIG. 3.

Referring to FIG. 3, the remote control device 200 can include a plurality of buttons. The plurality of buttons includes a fingerprint recognition button 212, power button 231, home button 232, live button 233, external input button 234, volume control button 235, voice recognition button 236, it can include a channel change button 237, a confirmation button 238, and a back button 239.

The fingerprint recognition button 212 can be a button for recognizing the user's fingerprint. In one embodiment, the fingerprint recognition button 212 is capable of a push operation and can receive a push operation and a fingerprint recognition operation.

The power button 231 can be a button for turning on/off the power of the display device 100.

The home button 232 can be a button for moving to the home screen of the display device 100.

The live button 233 can be a button for displaying a real-time broadcast program.

The external input button 234 can be a button for receiving an external input connected to the display device 100.

The volume control button 235 can be a button for adjusting the volume of the sound output by the display device 100.

The voice recognition button 236 can be a button for receiving the user's voice and recognizing the received voice.

The channel change button 237 can be a button for receiving a broadcast signal of a specific broadcast channel.

The confirmation button 238 can be a button for selecting a specific function, and the back button 239 can be a button for returning to the previous screen.

FIG. 2 will be described again.

If the user input interface 230 has a touch screen, the user can input commands related to the display device 100 through the remote control device 200 by touching a soft key on the touch screen. Additionally, the user input interface 230 can be provided with various types of input means that the user can operate, such as scroll keys and jog keys, and this embodiment does not limit the scope of the present invention.

The sensor 240 can include a gyro sensor 241 or an acceleration sensor 243, and the gyro sensor 241 can sense information about the movement of the remote control device 200.

For example, the gyro sensor 241 can sense information about the operation of the remote control device 200 based on the x, y, and z axes, and the acceleration sensor 243 measures the moving speed of the remote control device 200. Information about such things can be sensed. Meanwhile, the remote control device 200 can further include a distance measurement sensor and can sense the distance from the display 180 of the display device 100.

The output interface 250 can output a video or audio signal corresponding to a manipulation of the user input interface 230 or a signal transmitted from the display device 100.

The user can recognize whether the output interface 250 is manipulating the user input interface 230 or controlling the display device 100.

For example, the output interface 250 includes an LED 251 that turns on when the user input interface 230 is manipulated or a signal is transmitted and received with the display device 100 through the wireless communication unit 225, and a vibrator 253 that generates vibration, a speaker 255 that outputs sound, or a display 257 that outputs an image.

Additionally, the power supply circuit 260 supplies power to the remote control device 200, and stops power supply when the remote control device 200 does not move for a predetermined period of time, thereby reducing power waste.

The power supply circuit 260 can resume power supply when a predetermined key provided in the remote control device 200 is manipulated.

The memory 270 can store various types of programs, application data, etc. necessary for controlling or operating the remote control device 200.

When the remote control device 200 transmits and receives signals wirelessly through the display device 100 and the RF circuit 221, the remote control device 200 and the display device 100 transmit and receive signals through a predetermined frequency band.

The controller 280 of the remote control device 200 stores and references information about the display device 100 paired with the remote control device 200 and the frequency band capable of wirelessly transmitting and receiving signals in the memory 270.

The controller 280 controls all matters related to controlling the remote control device 200. The controller 280 transmits a signal corresponding to a predetermined key operation of the user input interface 230 or a signal corresponding to the movement of the remote control device 200 sensed by the sensor 240 through the wireless communication unit 225).

Additionally, the microphone 290 of the remote control device 200 can acquire voice.

A plurality of microphones 290 can be provided.

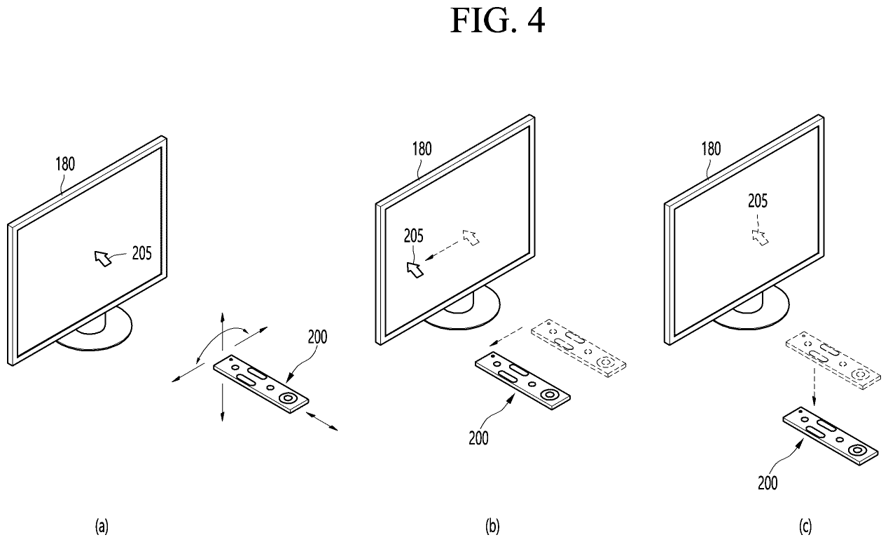

Next, FIG. 4 will be described.

FIG. 4 illustrates an example of utilizing a remote control device according to an embodiment of the present invention.

FIG. 4(a) illustrates that a pointer 205 corresponding to the remote control device 200 is displayed on the display 180.

The user can move or rotate the remote control device 200 up and down, left and right. The pointer 205 displayed on the display 180 of the display device 100 corresponds to the movement of the remote control device 200. This remote control device 200 can be called a spatial remote control because the corresponding pointer 205 is moved and displayed according to movement in 3D space, as shown in the drawing.

FIG. 4(b) illustrates that when the user moves the remote control device 200 to the left, the pointer 205 displayed on the display 180 of the display device 100 also moves to the left correspondingly.

Information about the movement of the remote control device 200 detected through the sensor of the remote control device 200 is transmitted to the display device 100. The display device 100 can calculate the coordinates of the pointer 205 from information about the movement of the remote control device 200. The display device 100 can display the pointer 205 to correspond to the calculated coordinates.

FIG. 4(c) illustrates a case where a user moves the remote control device 200 away from the display 180 while pressing a specific button in the remote control device 200. As a result, the selected area in the display 180 corresponding to the pointer 205 can be zoomed in and displayed enlarged.

Conversely, when the user moves the remote control device 200 closer to the display 180, the selected area in the display 180 corresponding to the pointer 205 can be zoomed out and displayed in a reduced size.

Meanwhile, when the remote control device 200 moves away from the display 180, the selected area can be zoomed out, and when the remote control device 200 approaches the display 180, the selected area can be zoomed in.

Additionally, when a specific button in the remote control device 200 is pressed, recognition of up-down, left-right movement can be excluded. That is, when the remote control device 200 moves away from or approaches the display 180, up, down, left, and right movements cannot be recognized, and only forward and backward movements can be recognized. When a specific button in the remote control device 200 is not pressed, only the pointer 205 moves as the remote control device 200 moves up, down, left, and right.

Meanwhile, the moving speed or direction of the pointer 205 can correspond to the moving speed or direction of the remote control device 200.

Meanwhile, a pointer in this specification refers to an object displayed on the display 180 in response to the operation of the remote control device 200. Accordingly, the pointer 205 can be an object of various shapes other than the arrow shape shown in the drawing. For example, concepts can include dots, cursors, prompts, thick outlines, etc. In addition, the pointer 205 can be displayed in correspondence to one of the horizontal and vertical axes on the display 180, as well as to multiple points, such as a line or surface.

Hereinafter, the correction data processing process of the panel in the display device 100 is optimized to efficiently operate the resource(s) of the display device 100, and thereby the power-on time of the display device 100 (Various embodiments of the present invention that can reduce power-on time are disclosed.

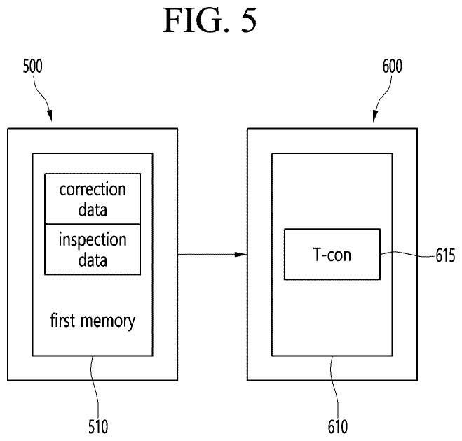

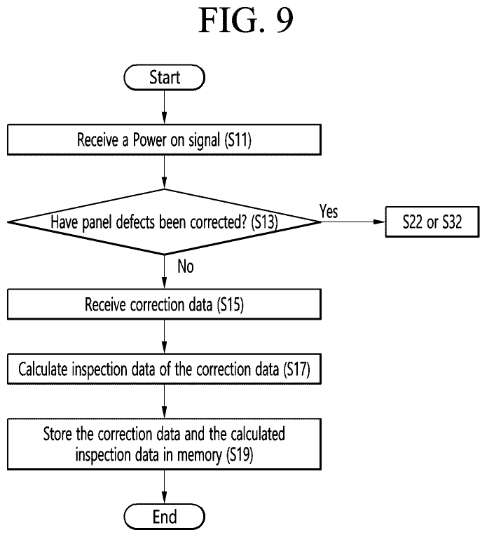

FIGS. 5 to 8 are diagrams illustrating correction data processing between an electronic device and a panel according to an embodiment of the present invention, and FIGS. 9 to 11 are diagrams illustrating correction data processing between an electronic device and a panel according to an embodiment of the present invention. This is a flowchart to explain the correction data processing process.

Here, the panel 500 can be a component corresponding to or included in the display 180 of the display device 100 shown in FIG. 1. In addition, the electronic device 600 can be, for example, a component corresponding to or included in the controller 170 of the display device 100 shown in FIG. 1, or can be a separate component not shown in FIG. 1. It could be an element. Meanwhile, the memory 630, which will be described later and included in the electronic device, can also correspond to or be included in the memory 140 of the display device 100 shown in FIG. 1. However, the present invention is not limited to this.

In the above, correction data can be defined as, for example, data for correcting (or compensating for) a defect occurring on the panel 500 of the display device 100. At this time, the defect occurring on the panel 500 can be mura, for example. Accordingly, the correction data can be demura data for solving defects, that is, mura, on the panel 500. However, since defects on the panel 500 to which the present invention can be applied are not limited to Mura, the correction data is also not limited to demura data.

In relation to this, the mura represents defects such as stains that can occur during the exposure process during the production process of the panel 500, and data for compensating or correcting such mura is demura data. That is, the mura on the panel 500 can be corrected using demura data.

Meanwhile, in the above, ‘power-on time’ can be defined as the time until the display device 100 outputs the initial screen upon receiving a power-on request signal, but is not necessarily limited to this. Depending on the embodiment, the power-on time can be defined differently.

In relation to this, the power-on request is generally made by a user, for example, through an input device such as the remote control shown in FIGS. 2 and 3, that is, the remote control device 200, but is not necessarily limited thereto. Depending on the embodiment, the display device 100 can independently perform a power-on request or power-on operation according to the occurrence of a predefined event.

In other words, when a power-on request signal is received, the display device 100 performs a preset operation through an application or program or outputs an initial screen when ready through a process. In this way, the initial screen is output. The predetermined time required to do this is called the power-on time. At this time, the problem is that if the power-on time is long, the user of the display device 100 can feel uncomfortable as the initial screen is provided late, and ultimately, the user's service satisfaction can decrease. Accordingly, a method for reducing or minimizing the power-on time of the display device 100 is required.

In the above, with regard to the power-on time, one of the preset operations performed by the display device 100 in response to a power-on request is a correction data processing process between the panel 500 and the electronic device 600. That is, when a power-on request is received, the display device 100 always reads the correction data of the panel 500 and processes it, which can result in a longer power-on time. For example, in order to process the correction data, data can be read or exchanged between the panel 500 and the electronic device 600 according to a predefined communication protocol. One of the predefined communication protocols can be included SPI (Serial Peripheral Interface) communication.

Table 1 illustrates the time required to read data (data read time) for each SPI communication clock (CLK: clock).

TABLE 1

| | |
|---|---|
| CLK | Read time |

| | | | |
|---|---|---|---|
| 0x28 | (10 MHz) | 1.4 | sec |
| 0x10 | (25 MHz) | 736 | ms |
| 0xC | (33 MHz) | 584 | ms |

According to Table 1, for example, if the SPI clock between the panel 500 and the electronic device 600 is 10 MHz, it takes about 1.4 seconds for the electronic device 600 to read correction data from the panel 500, this is directly reflected in the power-on time.

In this specification, in order to reduce or minimize the power-on time, among various operations performed in response to a power-on request, in particular, the panel correction data processing process is optimized to minimize the power-on time and quickly display the screen. Examples will be described.

Processing of correction data can be performed between the panel 500 and the electronic device 600 that constitute the display device 100. Meanwhile, the display device 100 according to the present invention can be, for example, a 4K TV, an 8K TV, etc.

Referring to FIGS. 5 to 8, the panel 500 can include or be linked to at least one memory 510 in which correction data and inspection data calculated with respect to the correction data are stored.

At this time, the inspection data can include correction data for compensating for panel defects (mura), that is, data used to verify the validity of demura data or check whether there has been a change. Additionally, the inspection data can be calculated, for example, from the correction data. According to an embodiment of the present invention, the test data can include Cyclic Redundancy Check (CRC) data to check whether there is an error in the transmitted data. Therefore, the test data can be CRC data of Demura data. However, test data according to the present invention is not necessarily limited to CRC data.

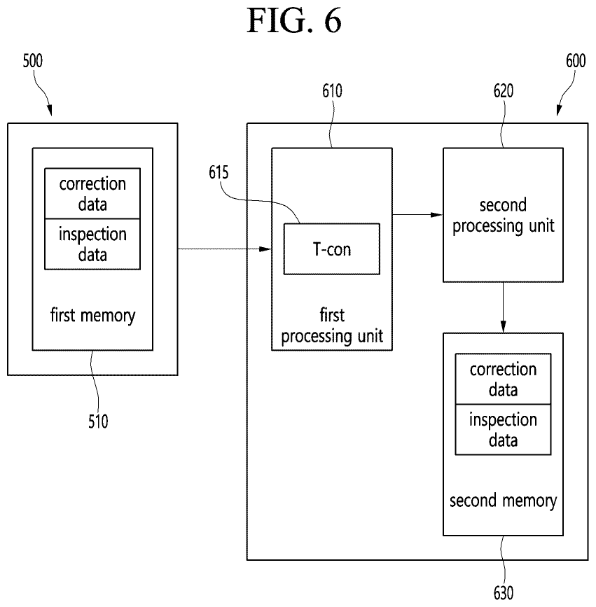

Meanwhile, the memory of the panel is called the first memory 510 for convenience to distinguish it from the memory of the electronic device 600 shown in FIGS. 6 to 9, and the memory of the electronic device 600 is therefore called the second memory. It is named and explained as 630.

The first memory 510 can be a serial flash memory, but is not necessarily limited thereto. Additionally, in FIGS. 5 to 8, although correction data and inspection data are depicted as being stored separately in the first memory 510, the present invention is not necessarily limited thereto. For example, only correction data can be stored in the first memory 510, and inspection data for the correction data can be stored in another memory of the display device 100 or in a remote location.

According to an embodiment of the present invention, as shown in FIG. 5, the electronic device 600 includes a first processor 610 and can read correction data from the panel 500 to correct defects in the panel.

According to another embodiment of the present invention, as shown in FIGS. 6 to 8, the electronic device 600 includes a first processor 610, a second processor 620, and a memory 630 to handle correction data.

For example, the electronic device 600 disclosed in this specification can be a device that drives the panel 500 to output an initial screen when a power-on request is received. This electronic device 600 can be the main board of the display device 100, or can be a component including the main board or a component included therein. However, the electronic device 600 according to the present invention is not limited to the above examples.

Referring to FIG. 5, the first processor 610 can read correction data from the first memory 510 of the panel to correct defects in the panel 500. The first processor 610 can store the correction data in memory. Here, the memory can be the same component as the second memory 630 shown in FIGS. 6 to 8, or can be a completely separate component.

In the above, the first processor 610 can correct defects in the panel using correction data read from the first memory 510 of the panel, but such defect correction is not always performed. For example, when the display device 100 is manufactured and powered on for the first time, the first processor 610 operates on a substrate such as the main board of the display device when the panel 500 of the display device is replaced. Defect compensation can only be performed if it has been replaced. However, the above-described defect correction performance can be arbitrarily changed.

Meanwhile, depending on the embodiment, the defect correction can be controlled by a user's request or the controller 170 of the display device 100.

In addition, according to another embodiment, the demura data-based defect compensation operation of the first processor 610, or a part or all operation of the first processor 610 including it, can be performed by the second processor 620.

FIGS. 5 to 8, the first processor 610 can include a timing controller (T-con) 615. Depending on the embodiment, the timing controller 615 can be included in another component of the display device 100 other than the first processor 610, for example, the second processor 620.

FIGS. 5 to 8, the first processor 610 and/or the second processor 620 can have volatile characteristics. On the other hand, the second memory 630 can be a non-volatile embedded multi-media controller (eMMC). However, the present invention is not limited to the above examples.

Referring to FIGS. 6 to 8, the first processor 610 can transmit data read from the first memory 510 to the second processor 620. At this time, the data cannot be correction data for compensating for panel defects, but can be inspection data for the correction data. That is, in FIGS. 6 to 8, the first processor 610 reads inspection data, not correction data, from the panel 500 and transmits it to the second processor 620, according to an embodiment of the present invention.

The second processor 620 can process inspection data received through the first processor 610.

The second processor 620 is a test data (hereinafter, for convenience of explanation, referred to as ‘first test data’) corresponding to the test data received through the first processor 610 (hereinafter, for convenience of explanation, referred to as ‘second test data’) can be read from the second memory 630.

Meanwhile, the second memory 630 can store correction data and inspection data received from the panel 500 in advance. For example, the display device 100 can require correction for defects on the panel 500 upon the first power-on request after manufacturing.

Here, the flow chart of FIG. 9 can be explained together with the drawing of FIG. 6, for example.

Referring to FIGS. 6 and 9, when the electronic device 600, for example, the first or second processor 610 or 620, receives a power-on request signal (S11), it can determine whether correction for the panel 500 has already been performed (S13).

As a result of the determination in step S13, if it is determined that the power-on request signal is received before correction for the panel 500 is performed, the first processor 610 is configured to compensate for the defect on the panel 500. Correction data can be read from the first memory 510 of the panel. The first processor 610 can compensate for defects in the panel 500 based on the read correction data.

The second processor 620 can receive correction data used to correct defects on the panel 500 from the first processor 610 (S15).

The second processor 620 can calculate inspection data based on the correction data received from the first processor 610 (S17).

The second processor 620 can store the correction data received from the first processor 610 in step S15 and the inspection data calculated in step S17 in the second memory 630 (S19).

As described above, FIGS. 6 and 9 can be viewed as a process of processing correction data when, for example, a defect on the panel 500 of the display device 100 is not corrected. As described above, the fact that defect correction of the panel 500 has not been performed means that the defect correction process is interrupted when the first power-on request is received after manufacturing the display device 100 or when the panel or main board is replaced. It can be seen as a case where it is requested again.

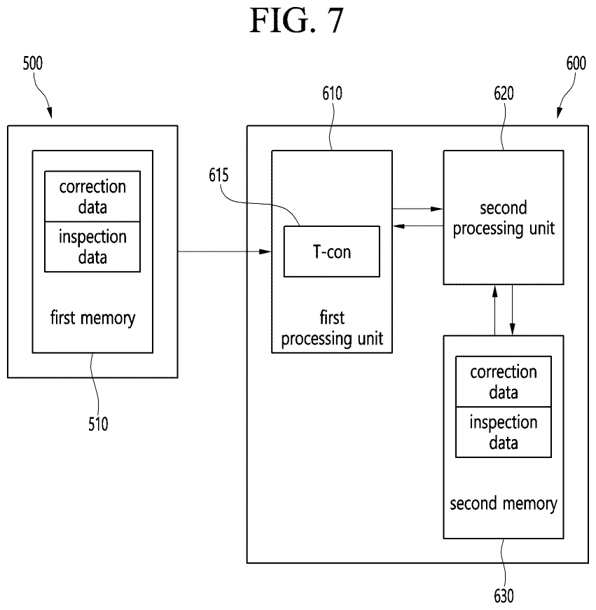

Accordingly, FIGS. 6 and 9 cannot be applied if the panel defect has already been corrected as a result of the judgment in process S13 of FIG. 9. In this case, as shown in FIG. 9, FIGS. 7 and 10 or 8 and 11 described later can be applied. As such, since the processing process of correction data can vary depending on the judgment, whether correction for defects on the panel 500 has been performed can be necessary to reduce power-on time according to the present invention. However, this cannot be viewed as a required process.

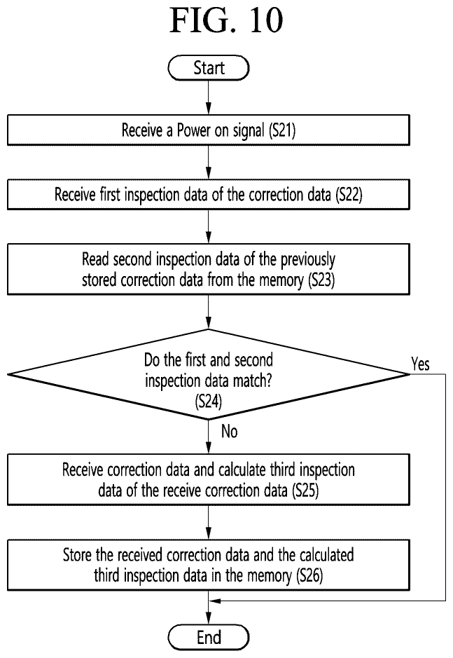

Another embodiment of the correction data processing process will be described with reference to FIGS. 7 and 10 as follows.

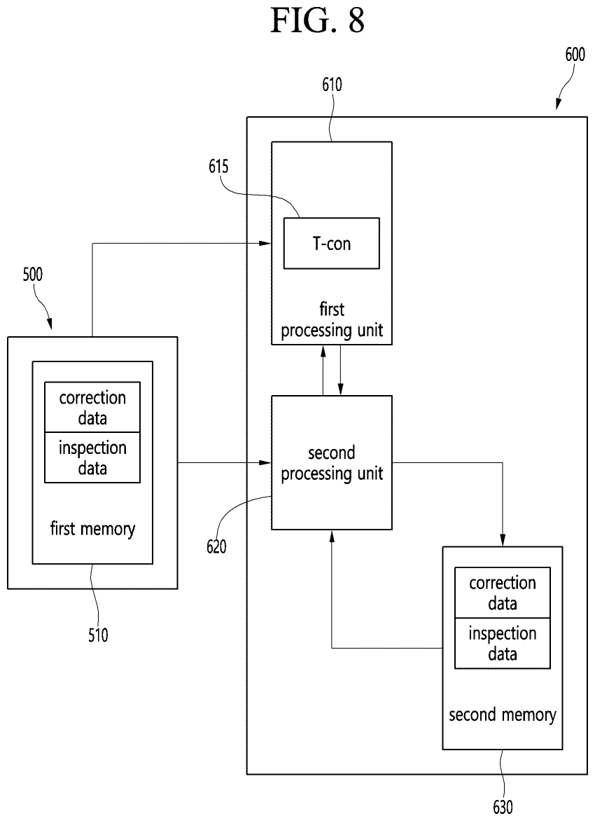

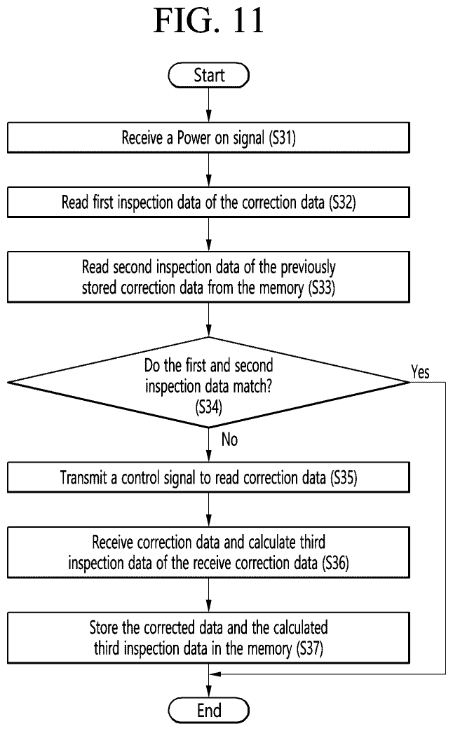

Compared to FIG. 6, it can be seen that the flow for processing the correction data in FIG. 7 is different. For example, referring to FIG. 6, it can be seen that not only is the inspection data not used in the correction data processing process, but the data is unilaterally transferred or transmitted from one component to another component. On the other hand, in relation to this embodiment, referring to FIG. 7, it can be seen that the correction data processing process not only involves two-way communication, but also uses inspection data for the correction data rather than correction data. In particular, the same applies to FIGS. 8 and 11 in that inspection data rather than correction data is used in the correction data processing process.

Referring to FIGS. 7 and 10, the electronic device 600, for example, the first or second processor 610 or 620, can receive a power-on request signal (S21).

At this time, the electronic device 600 can determine whether correction for the panel 500 has already been performed, for example, as in process S13 of FIG. 7 described above. However, in this embodiment, for convenience of explanation, it is assumed that correction for the panel 500 has already been performed.

The first processor 610 can read the inspection data of the correction data (first inspection data) rather than the correction data from the first memory 510 of the panel. Depending on the embodiment, the operation of the first processor 610 can be performed under the control of another component (e.g., the second processor 630). That is, the second processor 620 can request or control the first processor 610 to read inspection data rather than correction data from the first memory 510 of the panel in response to a power-on request.

The second processor 620 can receive the first inspection data read from the first memory 510 of the panel by the first processor 610 (S22).

When first inspection data is received from the first processor 610, the second processor 620 can read second inspection data corresponding to the first inspection data from the second memory 630 (S23).

The second processor 620 can read the second test data from the second memory through the step S23 and compare and determine whether it matches the first test data received in the step S22 (S24).

As a result of the comparison and determination in step S24, the second processor 620 determines that if the first inspection data and the second inspection data match each other, the first processor 610 does not need to perform correction from the first memory 510 of the panel. Since there is no need to read data, the correction data processing process can be terminated and controlled as is. The fact that the first inspection data and the second inspection data match each other means, for example, that the correction data stored in the first memory 510 of the panel has not been updated or changed afterward, so processing such as updating the correction data is no need to perform.

On the other hand, if the first inspection data and the second inspection data do not match each other as a result of the comparison determination in step S24, the second processor 620 determines that the correction data stored in the first memory 510 of the panel has been updated or changed. Since this correction data is correction data for defects on the panel 500, additional measures can be necessary to confirm or compensate for compensation for the panel 500.

Accordingly, the second processor 620 can control the first processor 610 to read correction data related to defect correction of the panel 500 from the first memory 510.

The second processor 620 receives correction data through the first processor 610, and when the correction data is received, it can calculate inspection data (third inspection data) for the correction data again (S25).

The second processor 620 can store the correction data received through the process S25 and the third test data calculated for the correction data in the second memory 630 (S26).

Meanwhile, in the above, just because the first processor 610 reads correction data from the first memory 510, it cannot necessarily mean that defects on the panel 500 must be corrected. This can vary depending on the result of the judgment as to whether defect correction on the panel 500 is necessary or not.

Another embodiment of the correction data processing process will be described with reference to FIGS. 8 and 11 as follows.

Compared to FIGS. 7 and 8 described above, it can be seen that the flow for processing correction data is different. For example, referring again to FIG. 6, it can be seen that not only was the inspection data not used in the correction data processing process, but the data was unilaterally transferred or transferred from one component to another. Referring to FIG. 7, the first processor 610 reads test data from the first memory 510 in response to a power-on request and transmits it to the second processor 620.

However, in relation to this embodiment, referring to FIG. 8, the second processor 620 can read inspection data from the first memory 510 instead of the first processor 610 of FIG. 7. Therefore, as will be described later, depending on the judgment of the second processor 620, the first processor 610 cannot operate during the processing of correction data, unlike FIGS. 5 to 7. Meanwhile, FIG. 8 also basically assumes that correction for defects on the panel 500 has already been performed.

Referring to FIGS. 8 and 11, the electronic device 600, for example, the first or second processor 610 or 620, can receive a power-on request signal (S31).

At this time, the electronic device 600 can determine whether correction for the panel 500 has already been performed, for example, as in process S13 of FIG. 7 described above. However, in this embodiment, for convenience of explanation, it is assumed that correction for the panel 500 has already been performed.

The second processor 610 can read inspection data (first inspection data) calculated for the correction data rather than correction data from the first memory 510 of the panel (S32).

The second processor 620 can read second test data corresponding to the first test data from the second memory 630 (S33).

The second processor 620 can compare and determine whether the read first test data and the second test data match each other (S34).

If the first test data and the second test data match each other as a result of the comparison and determination in step S34, the second processor 620 can terminate the process of processing correction data according to the power-on request. For example, the second processor 620 does not need to read correction data from the first memory 510 of the panel, and does not transmit any signal to the first processor 610. Alternatively, the first processor 610 can transmit a control signal not to read correction data or inspection data from the first memory 510 of the panel.

However, if the first inspection data and the second inspection data do not match each other as a result of the comparison determination in step S34, the second processor 620 determines that the correction data stored in the first memory 510 of the panel has been updated or changed. Therefore, the second processor 620 can control the first processor 610 and transmit a control signal to read correction data related to defect correction of the panel 500 from the first memory 510 (S35). However, depending on the embodiment, even in this case, if it is determined in advance through the first processor 610 that correction for defects on the panel 500 is not necessary, that is, only correction data is received from the first memory 510. If necessary, the correction data can be read directly from the first memory 510 by the second processor 620 rather than controlling the first processor 610 to receive the correction data.

The second processor 620 receives correction data through the first processor 610 through the S35 process, and when the correction data is received, it can calculate inspection data (third inspection data) for the correction data again (S36).

The second processor 620 can store the correction data received through the process S36 and the third test data calculated for the correction data in the second memory 630 (S37).

The correction data received in steps S26 of FIGS. 10 and S37 of FIG. 11 and the third inspection data calculated for the correction data are stored, but the previously stored correction data and the second inspection data are not deleted or deleted, and can be saved as is.

In this specification, a process of determining whether correction for defects on the panel 500 has already been performed and processing correction data according to a received power-on signal has been described, but the present invention is not limited thereto. In a similar manner, in the present invention, it is determined whether to perform correction for defects on the panel 500 or, regardless, first the presence or absence of correction data and/or inspection data previously stored in the memory (second memory) is determined, so it can be determined by it. For example, if correction for defects in the panel 500 has already been performed by the first processor 610 based on the correction data, the correction data and the correction are processed through the second processor 620 as shown in FIG. 6. It is preferable that the inspection data calculated for the data is already stored in the second memory 630.

Therefore, although not shown, when the electronic device 600 receives a power-on request, the second processor 620 transmits a request to read inspection data from the second memory 630, and it can be determined whether the panel 500 has performed correction based on the feedback data for the read request at step 630. Alternatively, if the second processor 620 is unable to read the inspection data from the second memory 630, it is assumed that compensation or correction for the panel 500 has not yet been made, for example, S15 in FIGS. 6 and 9. Processes through S19 can be performed. This process can be combined with the above-described embodiments to form a new process in order to increase the accuracy of determining defects in the panel 500.

Meanwhile, each step or process shown in FIGS. 9 to 11 can be operated differently from the sequence or step shown. For example, some of the processes shown in FIGS. 9 to 11 can be performed simultaneously. Additionally, some of the processes shown in FIGS. 9 to 11 can be omitted.

Depending on the embodiment, although the first processor 610 and the second processor 620 are shown and described as individual components in FIGS. 6 to 8, they can be modularized and form a single component.

Depending on the embodiment, the correction data optimization process for minimizing power-on time according to the present invention can further involve one or more of the components shown in FIGS. 5 to 8 or can be reversed.

In addition, in the embodiments of FIGS. 6 to 8, the comparison and determination process of the first inspection data and the second inspection data performed in the second processor 620 can be performed based on various methods or algorithms. Depending on the embodiment, artificial intelligence technology can be used in the comparison decision made in the second processor 620.

In addition, for example, if the display device is a digital signage installed in a specific space, or if the panel is frequently exposed to external contact or external environmental factors, the possibility of defects is high. An optimization process of correction data can be performed through any one of the embodiments or a combination thereof. As an example, taking the plurality of digital signages as an example, a process performed in one of the plurality of digital signages can affect other digital signages. If correction data is updated or processed in the first digital signage using any of the methods shown in FIGS. 6 to 8, the corresponding content can be reflected in other digital signage to minimize unnecessary processes in the correction data processing process. Conversely, the procedures determined above as necessary in the correction data processing process through one digital signage must be performed in other digital signage, so that risks can be prevented in advance.

Meanwhile, although not shown, if a user interface (UI) or OSD menu related to optimization of power-on time or fast power-on time is provided, the display device 100 basically displays the content determined through the interface. First, if the power-on time optimization item is selected, optimization of the correction data can be performed through any one of the methods of FIGS. 6 to 8 accordingly.

According to an embodiment of the present invention, the above-described method can be implemented as processor-readable code on a program-recorded medium. Examples of media that the processor can read include ROM, RAM, CD-ROM, magnetic tape, floppy disk, and optical data storage devices.

The display device described above is not limited to the configuration and method of the above-described embodiments, and the embodiments can be configured by selectively combining all or part of each embodiment so that various modifications can be made.

### INDUSTRIAL APPLICABILITY

The display device according to the present disclosure has the effect of dramatically reducing power-on time by optimizing the processing process of correction data used for panel defects, and thus has the potential for industrial use.

What is claimed is:

1. A display device comprising:
a first processor configured to read correction data from a panel and correct defects in the panel according to a reception of a power-on request signal; and
a second processor configured to receive the correction data from the first processor, calculate inspection data for the correction data, and store the received correction data and the calculated inspection data in a memory,
wherein the second processor is configured to control an operation of the first processor to read first inspection data calculated for correction data from the panel when a power-on request signal is received after defect correction of the panel.

2. The display device according to claim 1, wherein, when the power-on request signal is received, the second processor is configured to control the operation of the first processor by determining whether a defect in the panel has already been corrected.

3. The display device according to claim 2, wherein, when first inspection data is received from the first processor, the second processor is configured to read second inspection data corresponding to the first inspection data from the memory, and compare the first inspection data and the second inspection data.

4. The display device according to claim 3, wherein, when the first inspection data and the second inspection data are identical to each other based on the comparison result, the second processor is configured to control the operation of the first processor so as not to read correction data from the panel.

5. The display device according to claim 3, wherein, when the first inspection data and the second inspection data do not match based on the comparison result, the second processor is configured to control the operation of the first processor to additionally read correction data from the panel.

6. The display device according to claim 2, wherein the second processor is configured to determine whether to correct a defect in the panel by identifying whether the power-on request signal is the first received power-on request signal or whether the panel has been replaced, in determining whether to correct defects in the panel.

7. The display device according to claim 6, wherein, when the power-on request signal is a power-on request received for the first time after replacement of the panel, the second processor is configured to control the operation of the first processor to read correction data of the panel and correct defects of the panel.

8. The display device according to claim 1, wherein the first processor includes a timing controller.

9. The display device according to claim 1, wherein the panel and the first processor use a specific communication protocol, the specific communication protocol including Serial Peripheral Interface (SPI) communication.

10. The display device according to claim 1, wherein the correction data includes demura data.

11. The display device according to claim 1, wherein the test data includes Cyclic Redundancy Check (CRC) data.

12. A display device comprising:
a memory;
a first processor configured to read correction data from a panel and correct defects in the panel; and
a second processor, based on receiving a power-on request signal, configured to read the first inspection data of the correction data from the panel, read the second inspection data corresponding to the first inspection data from the memory, and controls the operation of the first processor to read correction data from the panel according to a comparison result of the first inspection data and the second inspection data.

13. The display device according to claim 12, wherein, when the first inspection data and the second inspection data match as a result of the comparison, the second processor is configured to control the operation of the first processor so as not to read correction data from the panel.

14. The display device according to claim 12, wherein, only when the power-on request signal is received after defects in the panel have already been corrected by the first processor, the second processor is configured to read first inspection data from the panel.

15. A method for operating a display device comprising:
receiving a power-on request signal;
reading correction data from a panel and correcting defects in the panel;
receiving the correction data and calculating test data for the correction data; and
storing the received correction data and calculated inspection data,
wherein, when the power-on request signal is received after defects in the panel are corrected, it is controlled to read inspection data of the correction data instead of correction data from the panel.
